(19) United States
(12) Patent Application Publication
(10) Pub. No.: US 2006/0080144 A1
(43) Pub. Date: Apr. 13, 2006

(54) System and method for providing healthcare management

(76) Inventors: Lalit Goel, Sunnyvale, CA (US); Srini Chintala, Houston, TX (US)

Correspondence Address: HAYES, SOLOWAY P.C., 175 CANAL STREET, MANCHESTER, NH, 03101, US

(21) Appl. No.: 11/229,990

(22) Filed: Sep. 19, 2005

Related U.S. Application Data
(60) Provisional application No. 60/610,662, filed on Sep. 17, 2004.

(51) Int. Cl. G06Q 10/00

(52) U.S. Cl. 705/2

(57) ABSTRACT

A system and method for purchasing and managing healthcare is provided. Generally, the system has a healthcare account manager with a database having user identification, accounts of credits associated with the user identification, healthcare service provider identification, and unit amounts associated with the healthcare services. The system also has a network and healthcare account manager terminal. The network connects one or more healthcare providers with the healthcare account manager terminal. The healthcare account manager terminal is capable of receiving information regarding a specific healthcare service performed by a specific healthcare provider on a specific user; determining from the database a specific amount of units associated with cost of the specific healthcare service performed; and reducing the number of units in an account associated with a specific user in the database, based on the determined specific amount of units associated with the specific healthcare service performed.

### CROSS-REFERENCE TO RELATED APPLICATIONS

This application claims priority to copending U.S. provisional application entitled, “Healthcare Management,” having Ser. No. 60/610,662, filed Sep. 17, 2004, which is entirely incorporated herein by reference.

### FIELD OF THE INVENTION

The present invention is generally related to a healthcare management method and system, and more particularly is related to a healthcare association that provides payment and oversight of healthcare providers.

### BACKGROUND OF THE INVENTION

Patients often have to rely on their doctors or insurance to make important decisions regarding their healthcare. Several different types of insurance plans have been developed to provide patients with affordable and quality healthcare. A fee-for-service plan is a traditional health insurance plan. According to these plans, a patient has the freedom to choose any doctor, specialist, or hospital. The patient pays a pre-determined percentage of the cost for healthcare services and the insurance company pays a pre-determined percentage of the cost or the remaining cost. These plans rely on the doctors to make the correct decisions and the patient to keep costs to a minimum. These plans have offered little help to patients in finding quality healthcare and keeping the costs to a minimum. Due to healthcare costs rising at significant rates, other insurance plans have been offered to provide more affordable healthcare.

Health Maintenance Organizations (HMOs) provide a network of doctors and specialists. Coverage under the plan usually requires the patient to see a doctor within the HMO network. If the patient requires a specialist, the patient must first visit a network doctor to authorize a visit to the specialist. While HMOs may or may not provide a reduction in medical costs, they may also remove the freedom of choice from the patient. The HMO decides the proper testing and treatment. The patient is often restricted from getting a second opinion that is covered under the insurance plan.

Recently, there has been a movement to remove insurance from low-budget healthcare, i.e. doctor visits for routine illnesses and accidents, such as viruses, broken bones, cuts, and infections. The rationale being, if patients are paying for these services out-of-pocket, they will be wiser consumers. Health Savings Accounts (HSAs) have been authorized by the federal government to provide tax breaks to individuals who elect to purchase high-deductible health insurance plans. The HSAs provide exemptions from federal income tax for a limited amount of specific healthcare items. The expectation is to provide an incentive for those individuals who wish to purchase insurance coverage for major healthcare expenses and to encourage comparative shopping for general healthcare expenses. However, these plans do not help individuals and employers identify quality and competitive healthcare providers, nor do they help individuals purchase complex healthcare items.

In addition to the above deficiencies and inadequacies, the current healthcare insurance systems also have drawbacks for the healthcare provider. Often healthcare providers must belong to the patient's insurance plan in order to get reimbursed by the insurance. Additionally, the reimbursement process often requires the provider to submit a claim after the services are provided and wait for approval before receiving reimbursement for the services provided. If the patient pays the healthcare provider directly, other problems may arise for the healthcare provider, such as a bounced check due to insufficient funds in the account.

Thus, an unaddressed need exists in the industry in order to address the aforementioned deficiencies and inadequacies.

### SUMMARY OF THE INVENTION

Embodiments of the present invention provide a system and method for providing healthcare management. Briefly described, in architecture, one embodiment of the system, among others, can be implemented as follows. The system has a healthcare account manager with a database having user identification, accounts of credits associated with the user identification, healthcare service provider identification, and unit amounts associated with the healthcare services. The system also has a network and healthcare account manager terminal. The network connects one or more healthcare providers with the healthcare account manager terminal. The healthcare account manager terminal is capable of receiving information regarding a specific healthcare service performed by a specific healthcare provider on a specific user; determining from the database a specific amount of units associated with cost of the specific healthcare service performed; and reducing the number of units in an account associated with a specific user in the database, based on the determined specific amount of units associated with the specific healthcare service performed.

The present invention can also be viewed as providing methods for providing healthcare management. In this regard, one embodiment of such a method, among others, can be broadly summarized by the following steps: creating an account for a user; depositing funds; converting funds into units and depositing the units into the account; debiting units from the account based on a service performed by a healthcare provider; converting the debited units into funds; and paying funds to the healthcare provider based on the debited units.

Other systems, methods, features, and advantages of the present invention will be, or will become apparent to one with skill in the art, upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a system diagram illustrating a general purpose computer architecture that can be used to implement the healthcare management system.

FIG. 2 is a block diagram illustrating a first embodiment of the healthcare management system and method.

FIG. 3 is a flowchart illustrating a method of implementing the first embodiment of the healthcare management system and method.

FIG. 4 is a schematic diagram illustrating the first embodiment of the healthcare management system and method.

FIG. 5 is a block diagram illustrating a second embodiment of the healthcare management system and method.

FIG. 6 is a flowchart illustrating a method of implementing the second embodiment of the healthcare management system and method.

FIG. 7 is a flowchart illustrating a first exemplary method of implementing the second embodiment of the healthcare management system and method.

FIG. 8 is a flowchart illustrating a second exemplary method of implementing the second embodiment of the healthcare management system and method.

FIG. 9 is a block diagram illustrating a third embodiment of the healthcare management system and method.

### DETAILED DESCRIPTION

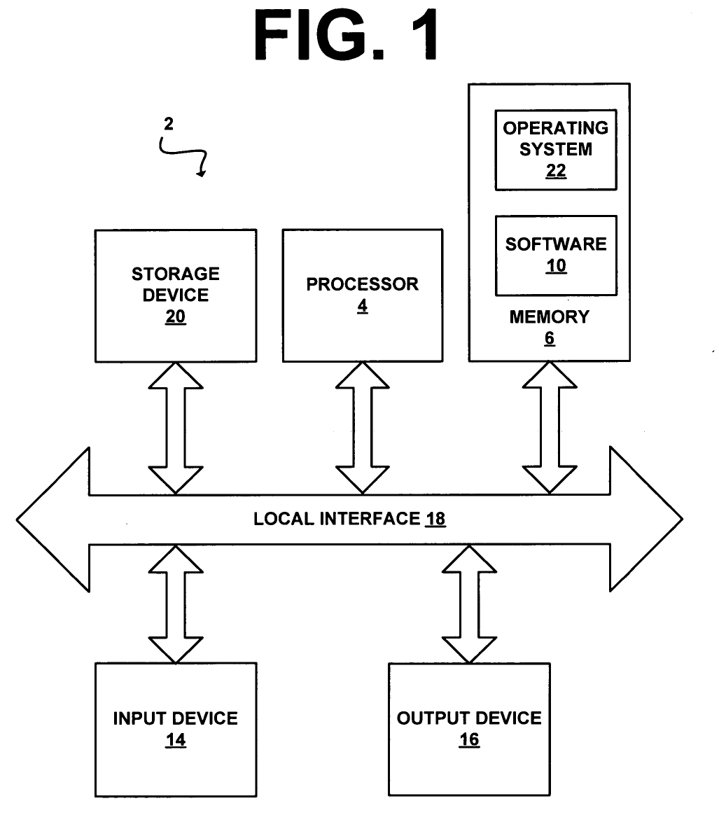

The present invention is a healthcare management method and system. The healthcare management method and system are designed to provide individuals and healthcare providers with a payment system and method. The healthcare management system can be designed to help individuals comparison shop for healthcare services and to provide a system and method that will ensure quality healthcare services. The healthcare management system and method can be implemented in software, firmware, hardware, or a combination thereof. All or a portion of the healthcare management system can be implemented in software, as an executable program, and can be executed by a special or general-purpose digital computer, such as a personal computer (PC), workstation, minicomputer, or mainframe computer. A general purpose computer architecture 2 can be used to implement the healthcare management system as shown in FIG. 1.

Generally, in terms of hardware architecture, as shown in FIG. 1, the computer architecture 2 of the healthcare management system and method includes a processor 4, a memory 6 capable of enabling execution of functions defined by software 10, one or more input devices 14 and output devices 16, or peripherals, and a storage device 20, all of which are communicatively coupled via a local interface 18. It should be noted that the storage device 20 may have numerous databases therein, as is described in detail below. The local interface 18 can be, but is not limited to, one or more buses or other wired or wireless connections, as is well known in the art. The local interface 18 may have additional elements that are omitted for simplicity, such as controllers, buffers (caches), drivers, repeaters, and receivers, which enable communication. Further, the local interface 18 may include address, control, and/or data connections to enable appropriate communications among the aforementioned components.

The processor 4 is a hardware device for executing software, particularly the software 10 stored in the memory 6. The processor 4 can be any custom-made or commercially available processor, a central processing unit (CPU), an auxiliary processor among several processors associated with the healthcare management system and method, a semiconductor-based microprocessor (in the form of a microchip or chip set), a macroprocessor, or generally any device for executing software instructions.

The memory 6 can include any one or a combination of volatile memory elements (e.g., random access memory (RAM), such as DRAM, SRAM, SDRAM, etc.) and nonvolatile memory elements (e.g., ROM, hard drive, tape, CD-ROM, etc.). Moreover, the memory 6 may incorporate electronic, magnetic, optical, and/or other types of storage media. Note that the memory 6 can have a distributed architecture, where various components are situated remotely from one another, but can be accessed by the processor 4.

The software 10 may include one or more separate programs, each of which comprises an ordered listing of executable instructions for implementing logical functions. In the exemplary computer architecture 2 of FIG. 1, the software 10 can define the functionality performed by the computer architecture 2 and an operating system (OS) 22.

The operating system 22 can control the execution of other computer programs, such as the software 10 of the healthcare management system, and provides scheduling, input-output control, file and data management, memory management, and communications control and related services.

The software 10 of the computer architecture 2 can be a source program, executable program (object code), script, or any other entity comprising a set of instructions to be performed. The source program may be translated via a compiler, assembler, interpreter, or the like, which may or may not be included within the memory 6, so as to operate properly in connection with the operating system 22. Furthermore, the software 10 of the computer architecture 2 can be written as (a) an object-oriented programming language, which has classes of data and methods, or (b) a procedural programming language, which has routines, subroutines, and/or functions.

The input devices 14 may include, for example, but not limited to, a keyboard, a mouse, a scanner, a debit/credit card scanner, or a microphone. Furthermore, the output devices 16 may include, for example, but not limited to, a printer or a display. Finally, the input devices 14 and output devices 16 may include devices that communicate both as inputs and outputs, for instance, but not limited to, a modulator/demodulator (e.g., modem, for accessing another device, system, or network), a radio frequency (RF) or other transceiver, a telephonic interface, a bridge, a router, or a touchscreen.

If the computer architecture 2 includes a PC, workstation, or the like, the software 10 in the memory 6 may further include a basic input output system (BIOS). The BIOS is a set of essential software routines that initialize and test the hardware at startup, start the operating system 22, and support the transfer of data among the hardware devices. The BIOS is stored in the read-only memory (ROM) so that the BIOS can be executed when the software 10 of the computer architecture 2 is activated.

While the computer architecture 2 is in operation, the processor 4 is configured to execute the software 10 stored within the memory 6, to communicate data to and from the memory 6, and to generally control operations of the computer architecture under the control of the software 10. The computer architecture 2 and the operating system 22, in whole or in part, are read by the processor 4, generally buffered and executed, within the processor 4.

The computer architecture 2 can also contain the storage device 20 for storing the various databases described herein. It should be noted that, in accordance with alternative embodiments of the invention, certain databases may be located external from the storage device 20, where information stored within an external database is transferred to the computer architecture 2 for use by the system.

The storage device 20 may be a computer readable medium that is removable, stationary, or stationary with a removable computer readable medium located therein. The storage device 20 may be an electronic, magnetic, optical, or other physical device or arrangement that can contain or store video and/or a computer program, for use by or in connection with the computer of the healthcare management system. Specifically, as is described in detail below, the storage device 20 has multiple databases located therein for use by the healthcare management system, as is described in detail below.

In the context of this invention, a computer readable medium is an electronic, magnetic, optical, or other physical device or arrangement that can contain or store a computer program for use by, or in connection with, a computer-related system or method. The healthcare management system and method can be embodied by any computer-readable medium for use by, or in connection with, an instruction execution system, apparatus, or device, such as a computer-based system, processor-containing system, or other system that can obtain the instructions from the instruction execution system, apparatus, or device and execute the instructions. In the context of this invention, a “computer-readable medium” can be any arrangement that can store, communicate, propagate, or transport the program for use by or in connection with the instruction execution system, apparatus, or device. The computer readable medium can be, for example, but not limited to, an electronic, magnetic, optical, electromagnetic, infrared, or semiconductor system, apparatus, device, or propagation medium. More specific examples of the computer-readable medium may include, but are not limited to, the following: an electrical connection (electronic) having one or more wires, a portable computer diskette (magnetic), a random access memory (RAM) (electronic), a (ROM) (electronic), an erasable programmable read-only memory (EPROM, EEPROM, or Flash memory) (electronic), or an optical disk such as a portable compact disc read-only memory (CD-ROM) (optical). The computer-readable medium could also be paper or other suitable medium upon which the program is printed, because the program can be electronically captured via optical scanning of the paper or other medium, compiled, interpreted, or otherwise processed in a suitable manner if necessary, and stored in a computer memory.

Moreover, each of the functional components of the present invention may be embodied as one or more distributed computer program processes running on one or more conventional general-purpose computers networked together by conventional networking hardware and software. Each of these functional components may be embodied by running distributed computer program processes on networked computer systems (e.g., comprising mainframe and/or symmetrically or massively parallel computing systems) including appropriate mass storage, networking, and other hardware and software for permitting these functional components to achieve the stated function. These computer systems may be geographically distributed and connected together via appropriate wide and local-area network hardware and software. The present invention may alternatively use the public Internet and Internet-compatible hyportext transfer protocol (HTTP) and user datagram protocol (UDP) protocols for the network interconnections described herein or other networks. The communications media described herein (generally referred to using the generic term “network”) may be a wired or wireless network, or a combination thereof.

Alternatively, the aforesaid functional components may be embodied by a plurality of separate computer processes stored on microprocessor-based personal computers networked together via conventional networking hardware and software, and including such other additional conventional hardware and software as is necessary to permit these functional components to achieve the stated functionalities. Such personal computers may be unable to run full-scale relational database engines of the types presented above. Therefore, in this alternative configuration, a non-relational flat file “table” may be included in at least one of the networked personal computers to represent at least portions of data stored by a system consistent with the present invention. The aforesaid functional components of a system consistent with the present invention may also comprise a combination of the above two configurations (e.g., by computer program processes running on a combination of personal computers, mainframes, symmetric or parallel computer systems, and/or other appropriate hardware and software, networked together via appropriate wide-area and local-area network hardware and software).

The healthcare management system and method can be implemented in hardware only. If implemented in hardware, the healthcare management system and method can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

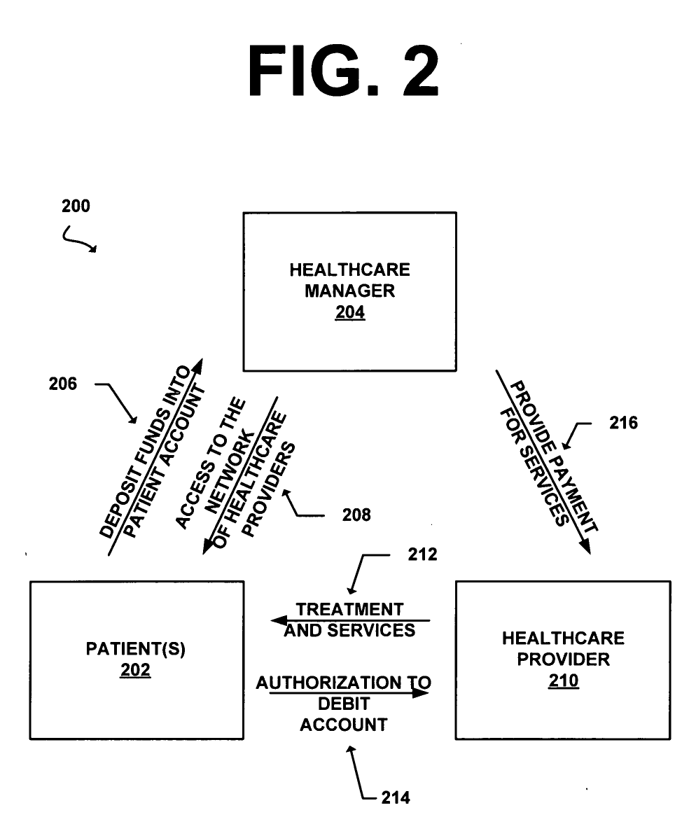

FIG. 2 is a block diagram illustrating a first embodiment of the healthcare management system and method 200. The patient 202 establishes an account with the healthcare manager 204. The patient 202 deposits funds into the account (arrow 206). The deposited funds can come from a number of different sources. The funds can be directly deposited by the patient 202, or deposited by friends or family of the patient 202. The employer of the patient 202 can also deposit funds into the account of the patient 200 as a part of a healthcare or wellness program provided by the employer. The funds can be deposited by transfer of funds (e.g., direct deposit by a bank), purchasing by cash payment, purchasing with a debit card, or by other means.

The healthcare manager 204 converts the funds into healthcare units. The healthcare units are stored in the account of the patient 202. The healthcare manager 204 provides the patient 202 with access to a network of healthcare providers or any healthcare provider (arrow 208). The patient 202 selects a healthcare provider 210 and contacts the healthcare provider 210 for healthcare services. Once the healthcare services have been provided (arrow 212) by the healthcare provider 210, the patient 202 authorizes the debit of units from the account of the patient 202 (arrow 214). The healthcare manager 204 converts the units into funds and pays the healthcare provider 210 for the services performed for the patient 202 (arrow 216).

In one exemplary embodiment of the first embodiment, the network of healthcare providers 210 has already negotiated with the healthcare manager 204 to determine the number of units for a specific health service. The negotiated fees can be set by, for example, the Independent Physicians Associations (IPA), individual or group practitioners, outpatient care centers, outpatient surgical centers, hospitals, HMO, service network providers, ancillary system providers, or medicare. The negotiated fees can take into account cost-of-living, and supply and demand for services, as well as other factors. The negotiated fees may also take advantage of bulk purchase orders for services. For example, the healthcare manager 204 can negotiate a set amount of X-rays for a given price from a specific hospital. The healthcare manager 204 can alert patients 202 about this discount in order to allow patients 202 to take advantage of the discount. Patients 202 may still choose to use a different hospital for convenience, or the patient 202 may decide to use the recommended hospital for the financial benefit offered to members of the health management system.

The negotiated discounts can be stored within a database of the healthcare manager 204. The healthcare manager 204 and/or the healthcare provider 210 can update the database. For example, if the healthcare provider 210 and healthcare manager 204 negotiate a price for 500 X-rays, the system can be designed to automatically update the database for each treatment performed. When the patient 202 receives the X-ray service and authorizes the debit of the account of the patient 202, the system can debit the account of the patient 202 and reduce the number of X-rays available at the negotiated price.

The healthcare manager 204 can alert patients 202 of negotiated discounts through various methods. As an example, the healthcare manager 204 can send patients 202 email updates, flyers, or can use other communication methods. The healthcare manager 204 can provide a hotline that allows patients 202 to call and speak to a representative of the healthcare manager 204. The representative can convey the various alternatives from which the patient 202 may select for healthcare services. The healthcare manager 204 can also provide a real-time web site that provides the location and fees for the various healthcare providers 210.

The healthcare units allow the healthcare managers 204 to create a commodity in the healthcare units. The healthcare manager 204 can provide an introductory price for healthcare units. As the healthcare manager 204 gains market prominence, the healthcare manager 204 can raise the cost for purchasing units. This allows the healthcare manager 204 to offer incentives to long-term patients 202. The healthcare manager 204 can also use the price of units to regulate cash flow in the system. For example, if the healthcare manager 204 is in need of additional cash flow, the healthcare manager 204 can offer a discount on healthcare units for a specific period of time. This will encourage patients 202 to deposit funds into their healthcare accounts, thus increasing the funds available to the healthcare manager 204.

In a second exemplary embodiment of the first embodiment, the account with the healthcare manager 204 is established for a group of patients 202. The units within the account are available to all the patients 202 associated with the account. For example, an employer may establish an account and deposit funds into the account. Participating employees of the employer are each given a debit card associated with the account. Each employee/patient 202 can use the debit card to purchase healthcare services from the healthcare providers 210. In another example, the debit card issued to each employee/patient 202 may limit the amount of units the employee/patient 202 is able to withdraw. In addition to the individual debit cards issued to each employee/patient 202, one or more master debit cards can be provided to a healthcare supervisor of the employer. The master debit cards may have access to a larger amount of units or the entire account. The healthcare supervisor can provide the master debit card to an employee/patient 202 for specific healthcare needs authorized by the healthcare supervisor. The system allows an employer to group healthcare expenses and benefit from a pulling of healthcare funds.

In another example the group account can be established for a family. The family can establish a family account with the healthcare manager 204. Each family member can be issued a debit card associated with the group account. Family members/patients 202 can deposit funds into the account for use by family members. Grandparents, children, and other family members can use the debit card to pay for healthcare services from the healthcare providers 210. The account allows the family to benefit from a pooling of funds. For example, a family member in his thirties may not need as many healthcare services as his grandparents, however, the family as a whole will spend about the same on average.

The system, according to this second exemplary embodiment can also be designed to limit the type or amount of healthcare service purchased by each patient 202 of the group account. For example, the group account may be established by an employer to pay only for dental healthcare service. The employer establishes the group account and funds the account. Each employee/patient 202 is issued a debit card. The system can be designed to only authorize a predetermined amount of units per employee/patient 202 for only healthcare providers 210 supplying dental healthcare services. The system can also be designed to authorize only specific healthcare services. For example, the dental healthcare services can be limited to predetermined non-cosmetic services. The system may authorize units for filling a cavity, but not authorize units for a teeth-whitening treatment.

In a third exemplary embodiment of the first embodiment, the debit card issued to patients 202 can be a gift card that authorizes a fixed amount of units or a pre-established fixed medical service. For example, a card can offer two office visits at the local doctor, five blood tests at the local labs, three immunizations, and/or an eye exam. Alternatively, the gift cards can be designed to provide a specific dollar amount of healthcare services. The gift card can take advantage of bulk discount pricing and help employers contribute to a healthier work force.

The gift card can have information associated with the healthcare services authorized by the gift card printed on the surface of the gift card. For example, addresses, phone numbers, service hours, and directions of the healthcare provider 210 can be printed on the front of the card. The gift card can also have the healthcare services authorized by the gift card printed on the surface of the gift card. For example, the card can list one eye check-up or one dental check-up.

The gift card can also be designed to allow the patient 202 to cash out the gift card. The patient 202 can return the gift card to the healthcare manager 204 or to an authorized merchant/healthcare provider 210 and receive the cash value of the gift card. The ability to cash out a gift card, can be predetermined by the purchaser of the gift card. The ability to cash out the gift card can also incorporate a penalty to cash out the gift card. For example, there can be a ten percent penalty fee for a patient 202 to cash out the gift card. Other limitation or benefits can also be incorporated with the gift card. For example, the gift card can be transferable to other individuals or limited to healthcare services for a specific individual.

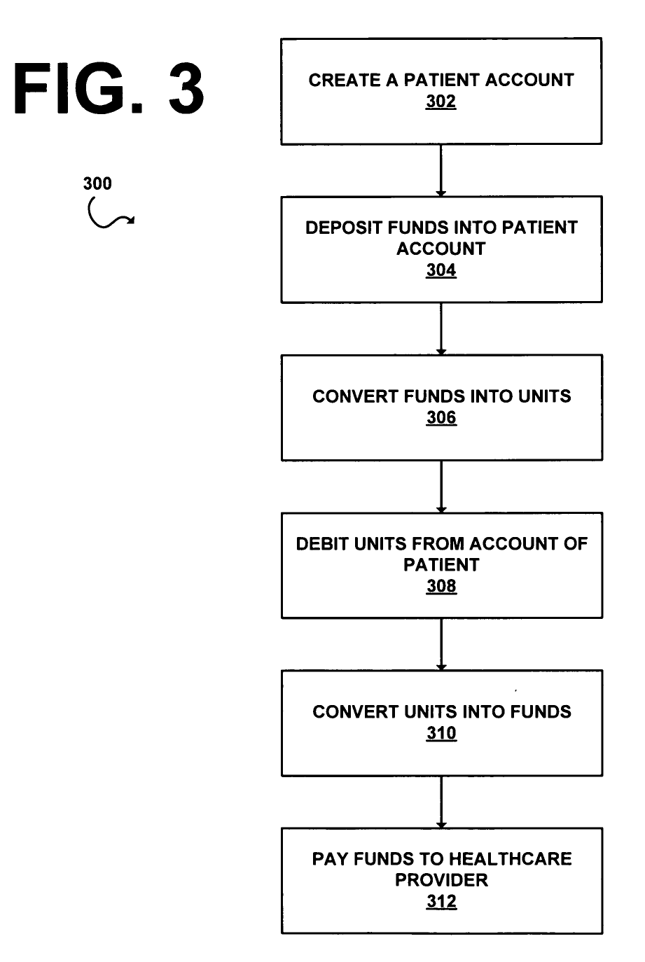

FIG. 3 is a flowchart illustrating a method of implementing the first embodiment of the healthcare management system and method 300. The process begins when the patient 202 creates an account with the healthcare manager 204 (block 302). The account is then associated with that patient 202. Additional information can also be associated with the account, for example the medical records of the patient 202 or other personal information. The patient 202 can deposit funds into the account (block 304). As previously discussed, the patient 202 or another person such as an employer can fund the account. The method 300 converts the funds into healthcare units based on the current exchange rate (block 306). The patient 202 has access to the account by purchasing healthcare services. The patient 202 receives services from a healthcare provider 210 and authorizes the debit of units by the healthcare manager 204 (block 308). The method 300 converts the specified units into funds (block 310) and transmits the funds directly to the healthcare provider 210 or to an account of the healthcare provider 210 (block 312), thus completing the healthcare transaction.

The patient 202 is not limited to using the deposited funds to purchase healthcare services. The patient 202 can give or bequeath the units to other patients or new patients of the healthcare management system. The patient 202 can also sell units to other patients or new patients of the healthcare management system. The patient 202 can also cash out the units with the healthcare manager 204 based on a certain rate. The healthcare management system allows a great degree of flexibility for the patient 202.

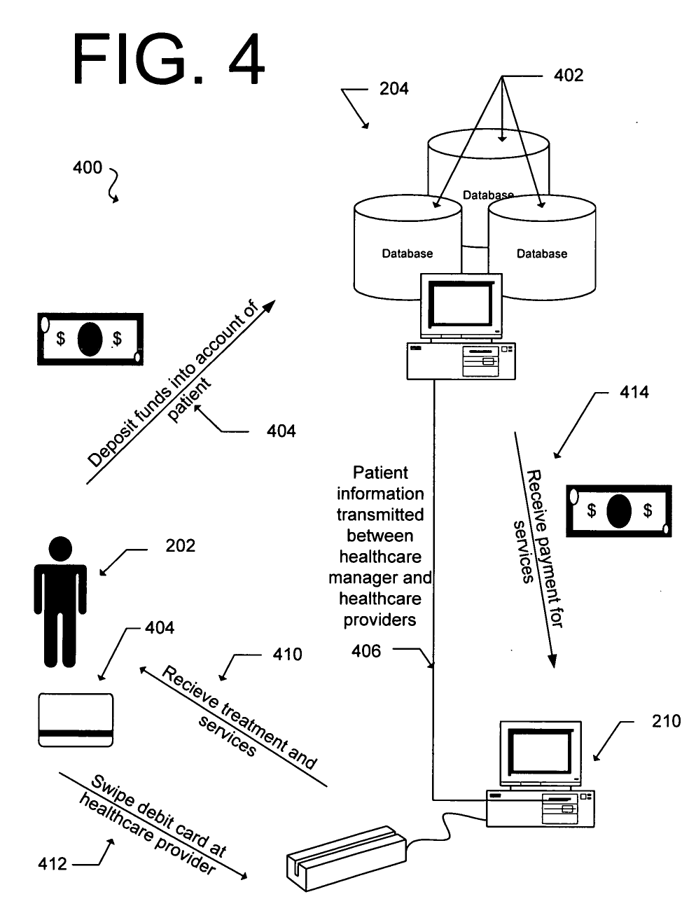

FIG. 4 is a schematic diagram illustrating the first embodiment of the healthcare management system and method 400. The patient 202 creates an account with the healthcare manager 204. The account information is stored in databases 402 of the healthcare manager 204, such as in the storage device 20 of FIG. 1. The patient 202 deposits funds in the account of the patient 202 (arrow 404). The healthcare manager 204 credits the account with the funds in the form of units. The patient 202 is issued a debit card 404, checks, or some other payment-authorizing device. A network 406 can link the healthcare manager 204 and healthcare provider 210. After the patient 202 receives healthcare services from a healthcare provider 210 (arrow 410), the patient 202 can use the debit card 404 or other payment device associated with the account of the patient 202 to authorize payment for the healthcare services (arrow 412). The network 406 transmits an identification code associated with the debit card 404 along with information associated with the healthcare provider 210 and an explanation of the services performed. Upon receipt of the information regarding the transactions, the healthcare management system debits the account of the patient 204, credits the healthcare provider 210 (arrow 414), and sends a confirmation to both parties, informing them that the transaction is complete.

The healthcare provider 210 can also preauthorize the transaction prior to performing the healthcare services. According to this example, the healthcare provider 210 may transmit the transaction information before performing the requested services. The healthcare management system will verify that the necessary units are in the account of the patient 204 and may place a hold on the specified amount of units for the services. Once the services are performed, the patient 202 or healthcare provider 210 can send a request to transfer the funds. This exemplary method allows the healthcare provider 210 to guarantee payment by the patient 202 prior to performing the services.

In addition to transmitting payment information, the network 406 and healthcare management system can also be designed to send healthcare providers 210 medical information associated with the patient 202. For example, when a patient 202 goes to a healthcare provider 210 for a service, the patient 202 can swipe the debit or healthcare card associated with patient 202. The healthcare management system can be designed to access a database containing the medical records of the patient. The network 406 can transmit the medical records of the patient 202 and a pre-authorization to the healthcare provider 210. When the services have been performed, the healthcare provider 210 or patient 202 can authorize the healthcare management system to update the medical records of the patient 202 and complete the payment transaction based on the services provided by the healthcare provider 210.

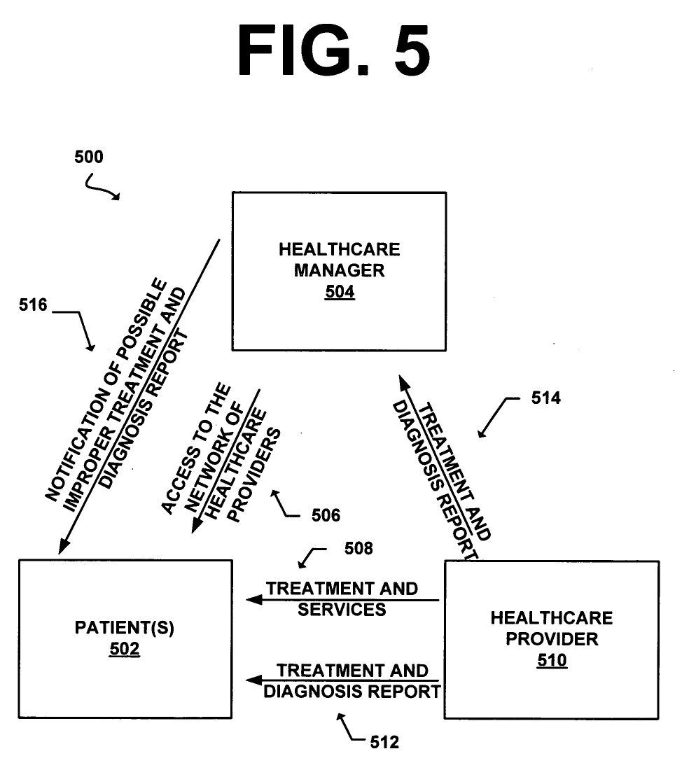

FIG. 5 is a block diagram illustrating a second embodiment 500 of the healthcare management system and method. The healthcare management system can be designed to assist individuals to better shop for healthcare services and provide a system and method to ensure quality healthcare services. The second embodiment of the healthcare management system 500 can be implemented in conjunction with the first embodiment 200 or independently of the first embodiment 200. The patient 502 establishes an account with the healthcare manager 504. The patient 502 is then given access to a network of healthcare providers (arrow 506). The patient 502 can be given information associated with each healthcare provider 510, for example but not limited to, reviews by previous patients 502, treatment and diagnostic statistics, educational background, and other information relevant to consumers.

When the patient 502 selects and receives treatment or services from a healthcare provider 510 (arrow 508), the healthcare provider 510 gives the patient 502 a treatment and diagnosis report (arrow 512). The treatment and diagnosis report can disclose information associated with the treatment of the patient 502, for example but not limited to, the symptoms displayed by the patient 502, tests or procedures recommended or performed by the healthcare provider 510, and other relevant information associated with treatment of the patient 502. A copy of the treatment and diagnosis report can also be sent to the healthcare manager 510 (arrow 514). The healthcare manager 504 reviews the treatment and diagnosis report for discrepancies or errors.

The review process by the healthcare management system can be performed by an automated review process, a personal review of the report by a medical professional, or a combination of both. In one example the process is completely automated. The treatment and diagnosis report is reviewed with a predetermined checklist to determine whether the proper tests were performed based on the symptoms or test results. The predetermined checklists can be stored in a database of the healthcare management system (e.g., database 20 of FIG. 1) and can provide a multitude of different checklists depending on the tests and symptoms of the patient 502. If an error is detected, the healthcare manager 504 sends a letter, email, or other communication to the patient 502 identifying and possibly explaining the discrepancy (arrow 516).

In another example, each treatment and diagnosis report can be reviewed by a professional to verify that the healthcare provider 510 performed the correct treatment and did not include any unnecessary treatments or tests. Similar to the previous example, if a discrepancy or error is determined, the patient 502 can be contacted and made aware of the possible discrepancies or errors. In yet another example, the review process involves a combination of both automation and professional review. According to this example, an automated review process flags possible discrepancies or errors. The medical professional reviews the flagged treatment and diagnosis reports to verify whether or not a discrepancy or error exists. The healthcare manager 504 then alerts the patient 502 of the discrepancies or errors that have been identified by the professional (arrow 516).

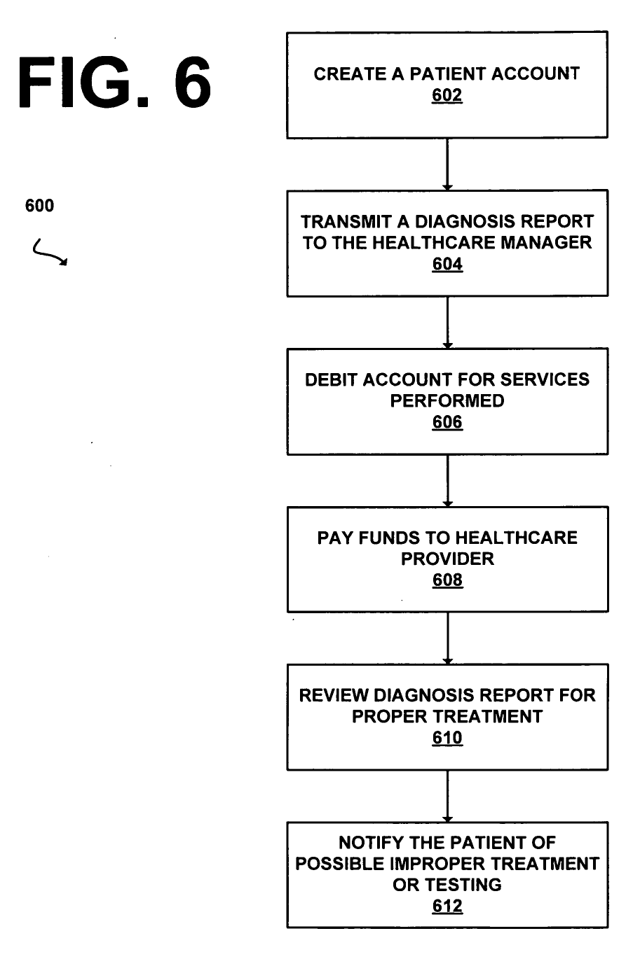

FIG. 6 is a flowchart illustrating a method of implementing the second embodiment of the healthcare management system and method 600. The patient 502 creates an account with the healthcare manager 504 (block 602) and receives treatment or services by a healthcare provider 510. A treatment and diagnosis report is transmitted to the healthcare manager 504 (block 604). The account of the patient 502 is debited a required number of units to pay for the services provided by the healthcare provider 510 (block 606). The funds are paid to the healthcare provider 510 (block 608). The treatment and diagnosis report is reviewed by the healthcare manager 504 (block 610) as described above. The healthcare manager 504 notifies the patient 502 of possible improper treatment or testing (block 612), if any.

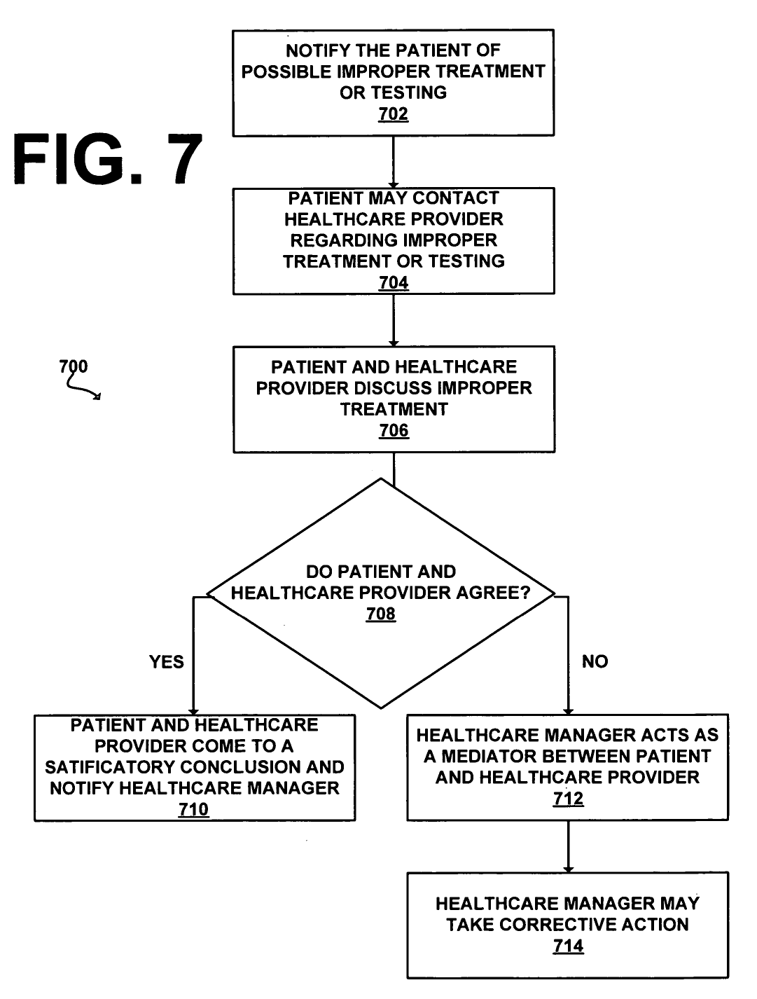

FIG. 7 is a flowchart illustrating a first exemplary method of implementing the second embodiment of the healthcare management system and method 700. According to the first exemplary method, the healthcare manager 504 may take a neutral position between the patient 502 and the healthcare provider 510. The healthcare manager 504 reviews the treatment and diagnosis report. Based on the review, the healthcare manager 504 determines if any improper treatment or testing was performed. If the healthcare manager 504 determines the treatment or the testing was improper, the healthcare manager 504 notifies the patient 502 (block 702). The patient 502 may contact the healthcare provider 510 regarding the improper treatment or test (block 704). The patient 502 may choose not to contact the healthcare provider 510 and ignore the notification of the improper treatment or test, for example, if the patient 502 personally requested the treatment. If the patient 502 chooses to discuss the possible improper treatment or testing with the healthcare provider 510, the two parties discuss the treatment (block 706). If the patient 502 and healthcare provider 510 come to an agreement (block 708), the patient 502 notifies the healthcare manager 504 (block 710) and the problem is resolved. If the patient 502 and healthcare provider 510 do not come to an agreement (block 708), the healthcare manager 504 may act as a mediator between the two parties (block 712). If the two parties are unable to resolve the dispute, the healthcare manager 504 may take a variety of corrective actions (block 714) or choose to not get involved. The healthcare manager 504 may note the dispute in a record associated with the healthcare provider 510, or may take a more aggressive approach and remove the healthcare provider 510 from the list of recommended healthcare providers.

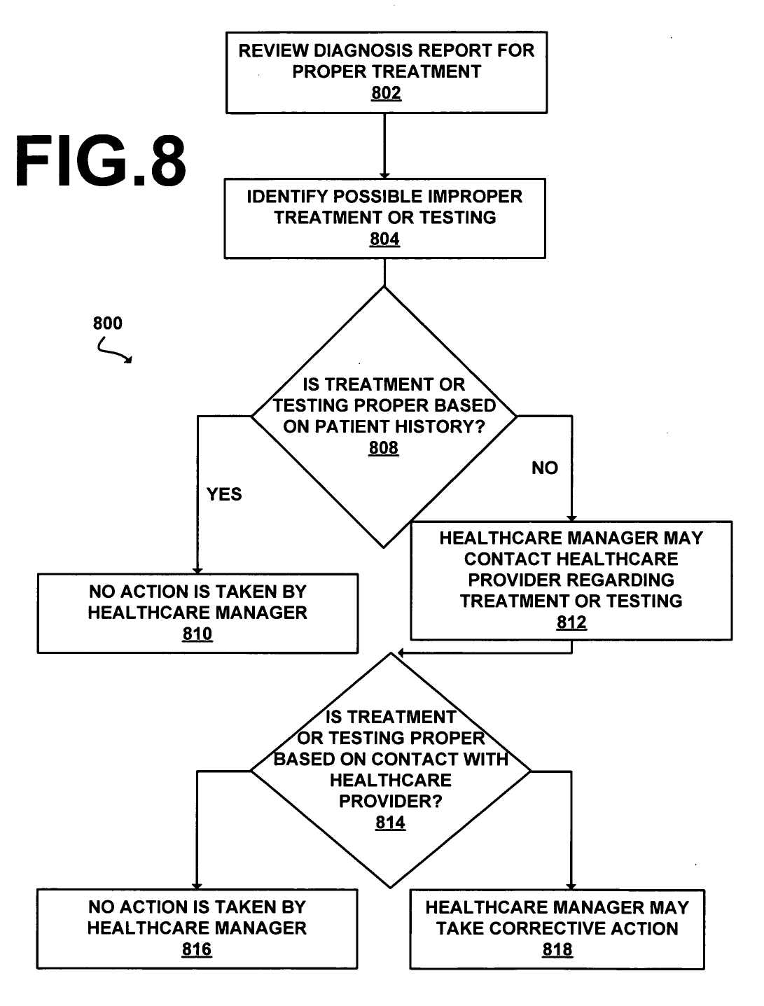

FIG. 8 is a flowchart illustrating a second exemplary method of implementing the second embodiment of the healthcare management system and method 800. According to the second exemplary method, the healthcare manager 504 may take additional steps to resolve the dispute concerning the improper treatment or testing. The healthcare manager 504 reviews the treatment and diagnosis report (block 802). Based on the review, the healthcare manager 504 determines if any improper treatment or testing was performed (block 804). The healthcare manager 504 may review the medical history of the patient 502 to determine if the treatment or testing was improper (block 804). If the treatment or testing was proper, based on the medical history of the patient 502 (block 808), the healthcare manager 504 may take no action (block 810). If the healthcare manager 504 determines the treatment or testing was still possibly improper based on the treatment and diagnosis report and the medical history of the patient 502 (block 808), the healthcare manager 504 may contact the healthcare provider 510 regarding treatment or testing (block 812). Based on the discussion with the healthcare provider 510 (block 814), the healthcare manager 504 determines if the treatment or testing was proper. If the healthcare manager 504 determines that the treatment or testing was proper, based on the discussion with the healthcare provider 510 (block 814), the healthcare manager 504 may take no further action (block 816). If the healthcare manager 504 determines that the treatment or testing is still improper, even after reviewing the medical history of the patient 502 and discussing the report with the healthcare provider 510, the healthcare manager 504 may notify the patient 502 and/or take corrective action as previously discussed (block 818). In all circumstances, the healthcare manager 504 can be in compliance with Health Insurance Portability and accountability Act (HIPAA) regulations concerning the medical history of the patient. It should be noted that in certain circumstances the healthcare manager may credit a patient account if the healthcare manager determines that the treatment was improper and/or not authorized by the patient. This alternative, of course, would be previously agreed upon before all parties become members of the present system and method.

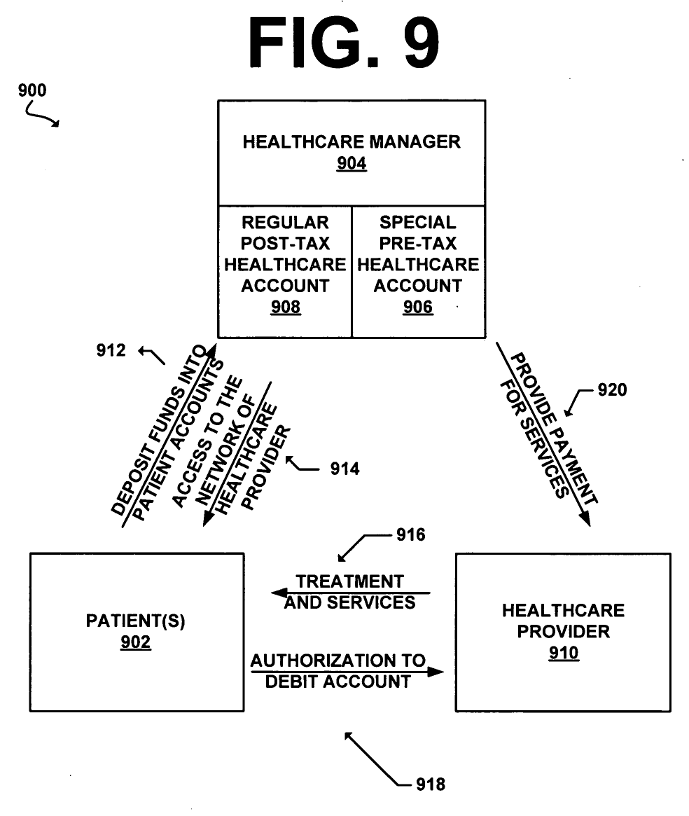

FIG. 9 is a block diagram illustrating a third embodiment of the healthcare management system and method 900. According to the third embodiment, aspects of the healthcare management system may be implemented in conjunction with a special pre-tax healthcare account 906. The special pre-tax healthcare account 906 can be separate from a regular post-tax healthcare account 908. The healthcare management system and method 900 can aid patients 902 in making efficient use of both their regular post-tax healthcare account 908 and their special pre-tax healthcare account 906.

The special pre-tax healthcare accounts 906 can be a variety of different flexible spending accounts authorized by either the state or federal government. A Health Savings Accounts (HSA) is an example of a special account set up to provide users federal tax-exempt use of money for healthcare purposes. The user establishes an account with a qualified HSA manager, which may act as the healthcare manager 904 or may implement the healthcare management system. Qualified HSA managers are organizations that comply with the Internal Revenue Service (IRS) regulations. The money can be deposited directly into a special pre-tax healthcare account 906 by the patient 902 or deposited by an employer of the patient 902. If a patient 902 deposits money into the account, the patient 902 can record the deposited money as an above-the-line deduction on their federal income tax return. This reimburses the patient 902 for federal income taxes paid on the money deposited into the account. If the employer deposits the money directly into the account, the payment is made tax-deferred. The HSA allows a patient 902 to spend federal tax-exempt income on approved health expenses.

To qualify for an HSA, under current IRS regulations, a patient 902 has to have a qualified high-deductible insurance plan. If the patient 902 has a qualified high-deductible insurance plan, the patient 902 can open an HSA through an HSA account managing service. The patient 902 can then deposit funds as previously discussed. The patient 902 is limited to an annual amount of deposit. Under current IRS regulations, a patient 902 cannot deposit more than $1000 for an individual or $2000 for a couple. The patient 902 is also limited to qualified expenditures for healthcare. The IRS publishes a list of qualified healthcare expenditures, for example, dental and doctor fees, eye care, drugs, etc.

Under an HSA, the patient 902 is responsible for keeping records of the expenditures to verify to the IRS that the expenditures were used on qualified healthcare expenditures. The HSA allows the patient 902 to roll over unused funds in the account 906 each year, unlike other flexible spending accounts. An HSA also allows a patient 902 to cash out any unused funds within the account 906. In order to cash out the account, 906 the patient 902 must pay the ordinary income tax and a ten percent penalty on the funds that are cashed out. Upon the death of the patient 902, the account may be credited to a surviving spouse. If there is no surviving spouse, the account 906 is cashed out, as described above, and the funds are included within the estate of the patient 902.

Referring to FIG. 9, the patient 902 establishes either a regular post-tax healthcare account 908 and/or a special pre-tax healthcare account 906 with the healthcare manager 904. The patient 902 deposits funds into the regular post-tax healthcare account 908 and/or the special pre-tax healthcare account 906 (arrow 912). The deposited funds can come from a number of different sources as previously discussed. The healthcare manager 904 converts the funds into healthcare units for the regular post-tax healthcare account 908 and may convert the funds in the special pre-tax healthcare account 906 if state or federal regulations permit. The healthcare units are stored in the account of the patient 902. The healthcare manager 904 provides the patient 902 with access to a network of healthcare providers 910 (arrow 914). The patient 902 selects a healthcare provider and contacts the healthcare provider 910 for healthcare services. Once the healthcare services have been provided by the healthcare provider 910 (arrow 916), the patient 902 authorizes the debit of units or funds from the accounts of the patient 902 (arrow 918). The healthcare manager 904 converts the units into funds and pays the healthcare provider 910 for the services performed on the patient 902 by the healthcare provider 910 (arrow 920).

The healthcare management method and system 900 can be used to help the patient 902 keep records of the expenditures to verify that the expenditures from the special pre-tax healthcare account 906 were used on qualified healthcare expenditures according to the state or federal regulations. The healthcare management method and system 900 can also be designed to more effectively use the pre-tax healthcare account 908 based on the state or federal regulations associated with the account 906. For example, the system can be designed to ensure all funds are spent in the special pre-tax healthcare account 908 prior to using the regular post-tax healthcare account 906. In another example involving a special pre-tax healthcare account 908 with regulations that do not permit funds to roll over each year, the healthcare management method and system 900 can be designed to alert the patient 902 of unused funds towards the end of the year. The healthcare management method and system 900 can be designed to send an email or letter to patients 902 with suggestions on possible healthcare expenditures, for example, filling a prescription or visiting a particular healthcare provider 910 for a service prior to the end of the year.

Aspects of the second embodiment of the healthcare management system and method may be incorporated as well into the third embodiment. The healthcare management method and system provides individuals and healthcare providers with a trouble-free and guaranteed payment system and method. The healthcare management system can be designed to help patients be wiser consumers for healthcare products and services. The healthcare management system and method can also provide a system and method that can help prevent and settle disputes between patients and healthcare providers.

The healthcare management system can also incorporate a variety of other healthcare services. In one example, the healthcare management system can offer body-enhancing procedures to individuals/patients 202 during their vacations, holidays, and other tours. For example, the healthcare management system may provide equipment and professionally staff a surgical center on a cruise ship or at a resort. This will allow individuals/patients 202 to fulfill their desire to go on vacation and also have body-enhancing procedures preformed while on vacation or away from home. Individuals/patients 202 can have a variety of body-enhancing procedures performed in a manner that is highly confidential and not so obvious to their coworkers and everyday acquaintances. Typically, body-enhancing procedures may take about three to five days for a full recovery and for the patient 202 to get back to their daily routine. By integrating vacation or other time away from home with the body-enhancing services, individuals/patients 202 can accomplish the desire to modify their looks in a non-conspicuous way.

The healthcare management system can offer the body-enhancing procedures on a continual basis or for a limited time period. For example, the healthcare management system can offer the services for a limited number of cruises. Individuals/patients 202 may be notified by the healthcare management of the services and may make reservations for the limited number of cruises. The individual/patients 202 can pay for both the cruise and the body-enhancing procedure with the account of the individual/patient 202 maintained by the healthcare manager 204. The healthcare management system can also offer the body-enhancing services on a continual basis that rotates to a variety of vacation destinations. For example, the body-enhancing service can be offered at a beach resort during the summer months, at a mountain resort during the fall months, on a cruise ship during the winter, and at a historical or amusement resort during the spring months. This allows an individual/patient 202 to have body-enhancing procedures while customizing their vacation.

The healthcare management system allows the healthcare manager 204 to organize and arrange the body-enhancing service with various vacation destinations. The healthcare manager 204 also can book and arrange the individuals/patients 202 ordering the body-enhancing service. The healthcare manager can also make the arrangements with the healthcare provider 210 for the body-enhancing service. The healthcare provider 210 does not have to be concerned with marketing and arranging the body-enhancing services. The healthcare provider 210 can be paid through the healthcare manager 204 and does not have to be concerned with booking individuals/patients 202 for the service or payment by the individuals/patients 202 for the body-enhancing service.

It should be emphasized that the above-described embodiments of the present invention, particularly, any embodiments, are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

What is claimed is:

1. A method for purchasing health services, comprising:
creating an account for a user;
depositing funds;
converting funds into units and depositing the units into the account;
debiting units from the account based on a service performed by a healthcare provider;
converting the debited units into funds; and
paying funds to the healthcare provider based on the debited units.

2. The method for purchasing healthcare services of claim 1, wherein the account is for multiple users.

3. The method for purchasing healthcare services of claim 1, further comprising the steps of:
debiting units from the account based on a withdrawal by the user;
converting the debited units based on the withdrawal by the user into funds based on the withdrawal by the user; and
paying funds to the user based on the withdrawal by the user.

4. The method for purchasing healthcare services of claim 1, wherein the healthcare provider is a member of a network that has agreed to provide a given service in exchange for a fixed unit amount.

5. The method for purchasing healthcare services of claim 1, wherein the units are transferable to a separate user account.

6. The method for purchasing healthcare services of claim 1, wherein the step of depositing funds may be performed by directly depositing the funds from a bank, using a credit card, or paying cash.

7. The method for purchasing healthcare services of claim 1, wherein the step of depositing funds is performed by using a peripheral device.

8. A system for purchasing healthcare services, comprising:
a healthcare account manager database comprising user identifications, accounts of units associated with the user identifications, healthcare service provider identifications, and unit amounts associated with the healthcare services;
a network connecting one or more healthcare providers with a healthcare account manager terminal; and
the healthcare account manager terminal being capable of performing the steps of:
receiving information regarding a specific healthcare service performed by a specific healthcare provider on a specific user;
determining from the database a specific amount of units associated with cost of the specific healthcare service performed; and
reducing the number of units in an account associated with a specific user in the database, based on the determined specific amount of units associated with cost of the specific healthcare service performed.

9. The system for purchasing healthcare services of claim 8, wherein the healthcare account manager terminal is further capable of performing the steps of:
receiving an amount of funds;
calculating the amount of units based on the amount of funds; and
increasing the account associated with the specific user in the database by a number of units based on the determined specific amount of units associated with the amount of funds.

10. The system of claim 9, wherein the amount of funds received is received from the specific user.

11. The system of claim 9, where the amount of funds received is received from a party other than the specific user.

12. The system of claim 8, wherein the account associated with the specific user is also associated with a number of other users.

13. The system of claim 8, wherein the healthcare account manager terminal is also capable of increasing the number of units in the account associated with the specific user.

14. The system for purchasing healthcare services of claim 9, wherein the healthcare account manager terminal further comprises a peripheral device for assisting in the receipt of the amount of funds.

15. The system for purchasing healthcare services of claim 9, wherein the healthcare account manager terminal is connected to a network.

16. A method for purchasing healthcare services, comprising the steps of:
creating an account for a patient with a healthcare account manager;
transmitting a diagnosis report from the healthcare provider to the healthcare account manager;
debiting units from the account based on a service performed by a healthcare provider;
paying funds to the healthcare provider based on the debited units; and
reviewing the diagnosis report for proper treatment and testing.

17. The method of claim 16, further comprising the step of notifying the patient of possible improper treatment or testing.

18. The method of claim 16, further comprising the step of adding units to the account if improper treatment or testing was performed.
